(19) United States
(12) Patent Application Publication
(10) Pub. No.: US 2009/0284616 A1
(43) Pub. Date: Nov. 19, 2009

(54) IMAGE SIGNAL PROCESSING CIRCUIT

(75) Inventor: Hiroshi DAIKU, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED, Kawasaki (JP)

(21) Appl. No.: 12/273,210

(22) Filed: Nov. 18, 2008

(30) Foreign Application Priority Data
Nov. 19, 2007 (JP) 2007-299085

(51) Int. Cl. H04N 5/235; H04N 9/68

(52) U.S. Cl. 348/229.1; 348/234; 348/E05.037; 348/E09.053

(57) ABSTRACT

A signal processing circuit for processing a luminance signal received from an image sensor, including: a correction circuit correcting characteristics of a luminance signal from the image sensor in reverse relation to luminance characteristics of a display device; and a gain control section performing gain control of the luminance signal from the image sensor based on the luminance signal from the image sensor, wherein the gain control section receives an input signal corresponding to the luminance signal before correction in the correction circuit.

### CROSS-REFERENCE TO RELATED APPLICATION

This application is based upon and claims the benefit of priority of the prior Japanese Patent Application No. 2007-299085, filed on Nov. 19, 2007, the entire contents of which are incorporated herein by reference.

### BACKGROUND

1. Field

Aspects of the embodiments discussed herein are directed to an image sensor.

2. Description of the Related Art

In recent years, many image sensors have been used in products such as digital still cameras and mobile terminals. Digital cameras perform an automatic exposure adjustment function (AE: Auto-Exposure). This function automatically adjusts the gain of the camera's signal amplifier and the exposure time so that the display maintains a constant brightness even if the environmental brightness changes. Usually, the adjustment is performed such that the screen luminance is read for every frame, and the ratio of the read luminance to the brightness to be maintained (target luminance) is calculated. Based on the calculation result, the exposure time and the gain are adjusted to provide a display image with constant brightness.

FIG. 8 illustrates an exemplary conventional image signal processing circuit.

A signal input from an image sensor (not shown) is adjusted for the image quality or the like in an image processing circuit for image quality adjustment 10, and is then input to a gamma correction circuit 11. The gamma correction circuit 11 adjusts the screen luminance. Next, the signal is input to an output-format conversion circuit 12. The output-format conversion circuit 12 converts the format of the signal from the image sensor into a format for display, and outputs the signal for the image display. The AE function is controlled by an AGC (Auto Gain Control) circuit 13. The AGC circuit 13 acquires an output of the gamma correction circuit 11, then adjusts the exposure time of the image sensor or the amplification factor (gain) of the signal.

A conventional image taking device is disclosed in Japanese Patent Laid-Open No. 2002-33956. This Japanese Patent Laid-Open No. 2002-33956 discloses an image taking device aimed at enlarging the dynamic range by performing both gain increase and alteration of gray-scale-conversion characteristics (gamma circuit).

### SUMMARY

Aspects of the embodiments discussed herein include providing a signal processing circuit for processing a luminance signal from an image sensor, including: a correction circuit for correcting characteristics of a luminance signal from the image sensor, the correction being in reverse relation to luminance characteristics of a display device; and a gain control section for performing gain control of the luminance signal from the image sensor based on the luminance signal from the image sensor, wherein the gain control is performed on the luminance signal before correction of the luminance signal in the correction circuit.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 illustrates aspects of a principle of an embodiment.

FIG. 2 illustrates a block diagram of aspects of an image signal processing circuit in accordance with an embodiment.

FIG. 3 illustrates a flowchart (flowchart No. 1) for processing to make a control cycle faster or slower.

FIG. 4 illustrates a flowchart (flowchart No. 2) for processing to make the control cycle faster or slower.

FIG. 5 illustrates a block diagram of aspects of an image signal processing circuit in accordance with a second embodiment.

FIG. 6 illustrates a block diagram of aspects of a typical digital camera.

FIG. 7 illustrates a block diagram of aspects of the image sensor of FIG. 6.

FIG. 8 illustrates an exemplary conventional image signal processing circuit.

### DETAILED DESCRIPTION OF THE EMBODIMENTS

Screen luminances of a digital camera, in the case of an 8-bit output, are digitized to output a value between a 0th to 255th order code to be output. In both a bright environment and a dark environment, the target luminance is typically set around the 120th code, which is an intermediate value among the 255 digitized values. When the digital camera moves from a bright environment where the luminance has converged at the intermediate value to a dark environment, the corresponding value for the luminance of the dark environment falls among 0th to 120th codes, as described hereafter, and no problem arises. However, when the digital camera moves from a dark environment to a bright environment, where the luminance can increase 10 to 100 times, it is unlikely that a corresponding luminance for the bright environment exists among 120th to 250th codes.

In the case of transition from a brighter environment to a darker environment, a follow-up operation is carried out as follows. When, for example, the AE has settled at a luminance code of 120 in a first brighter environment of 1000 Lx (lux) luminance and then the environment changes to a dark state such as 50 Lx (lux), the luminance has changed to 1/20 of the first brighter level. The code value of the environment should be 1/20 of the original 120th code or 120/20=6. Therefore, the corresponding value for the darker environment should be the 6th code, so that the change of luminance (120/6=20 times) may be followed.

On the other hand, conversely, when AE has first settled at the luminance of 120 in first darker environment of 50 Lx and then the environment changes to a brighter 1000 Lx luminance, the luminance increases 20 times and, therefore, an output of 2400th code (120×20=2400) is desired. However, the outputable luminance only ranges from between the 0th to 255th codes, as mentioned above. Therefore, a limiter operates on 2400 to make it the 255th code. With this limitation, only a follow-up operation of 0.47 time (120/255=0.47) is available, although the follow-up operation of 0.05 time (120/2400=0.05) is desired. In order to realize the desired 0.05 time, the same calculations are repeated several ten times until this 0.05 time is realized, resulting in a low follow-up speed.

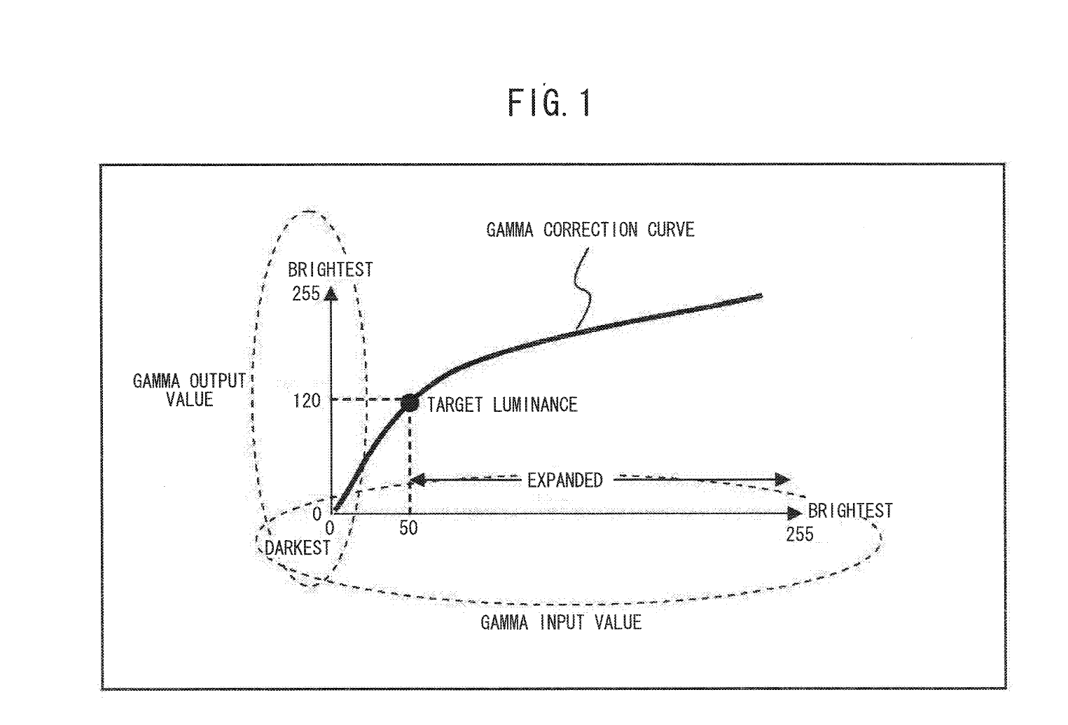

FIG. 1 illustrates aspects of a principle of an embodiment.

The digital camera has a gamma correction function. In order to correct the gamma curve of an output monitor, a correction is performed by a gamma curve corrector in reverse relation to the gamma curve of the monitor, as illustrated in FIG. 1. In the embodiment, the luminance calculation is performed with an input value in the gamma correction, i.e., the value before the gamma curve corrector, and then AE function is performed.

That is, since the gamma curve for the gamma correction assumes a curve which is heading toward a positive constant value as the positive gradient attenuates, as illustrated in FIG. 1, the input value corresponding to the target luminance of 120th code in the output can be made as low as about the 50th code, so that, for the gamma input value, the range therefrom to the maximum 255th code can be expanded. That is, since it becomes possible to follow up to 50/255=0.20 time when the digital camera moves from a bright environment to a dark environment. The number of calculations can be decreased and the follow-up speed can be increased 4 times compared with the case where the output value are used (120/255=0.47). In addition, the follow-up speed of AE can be changed according to the read luminance. For example, if the setting is made for responding at a speed twice the usual speed in the case of luminances exceeding the 200th code, the response speed can be made twice fast.

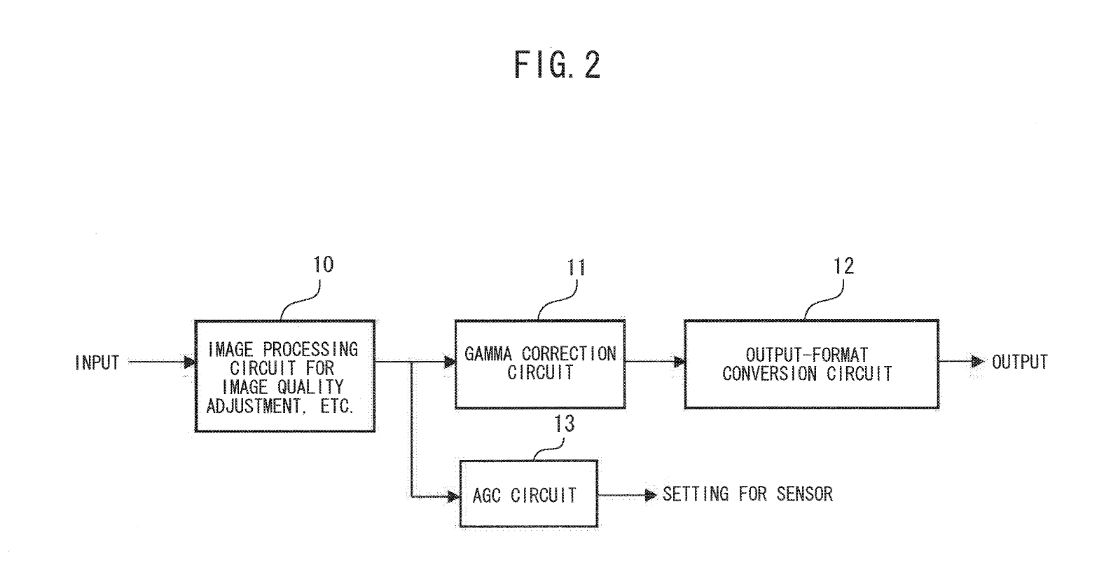

FIG. 2 is a block diagram of an image signal processing circuit in accordance with aspects of an embodiment.

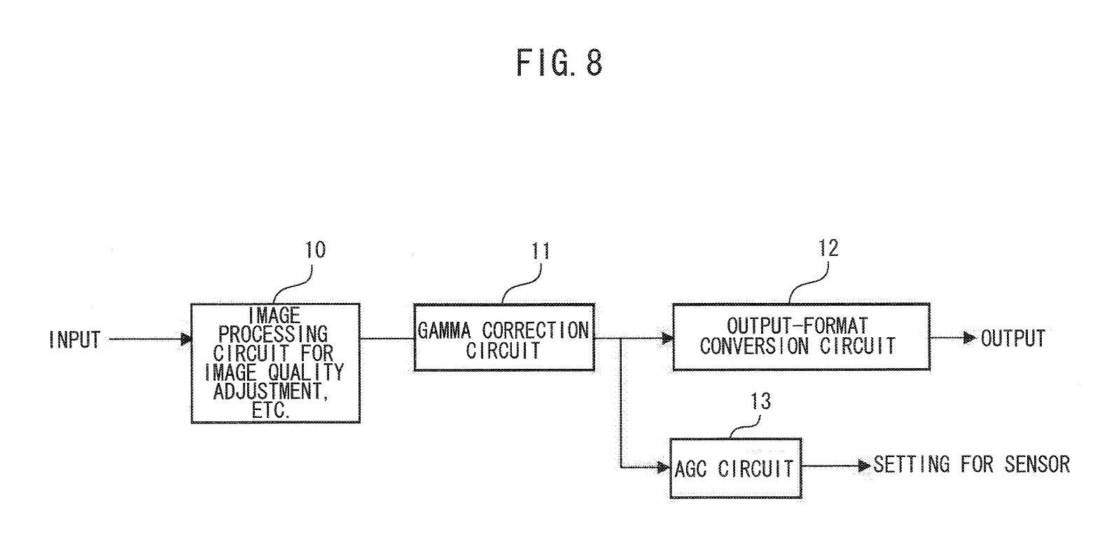

In FIG. 2, like reference numerals are given to like elements as illustrated in FIG. 8, and the detailed description of these elements is omitted.

In FIG. 2, a signal input from an image sensor (not shown) is adjusted for image quality or the like in an image processing circuit for adjusting image quality 10, and is then input to a gamma correction circuit 11. An AGC circuit 13 is coupled to the image processing circuit before the gamma correction circuit 11, and acquires the same input values that are input to the gamma correction circuit 11. Since the AGC circuit 13 performs AE function using the value input to the gamma correction circuit 11, when moving from a bright environment to a dark environment, the speed of the AE function can be increased, as described above with FIG. 1.

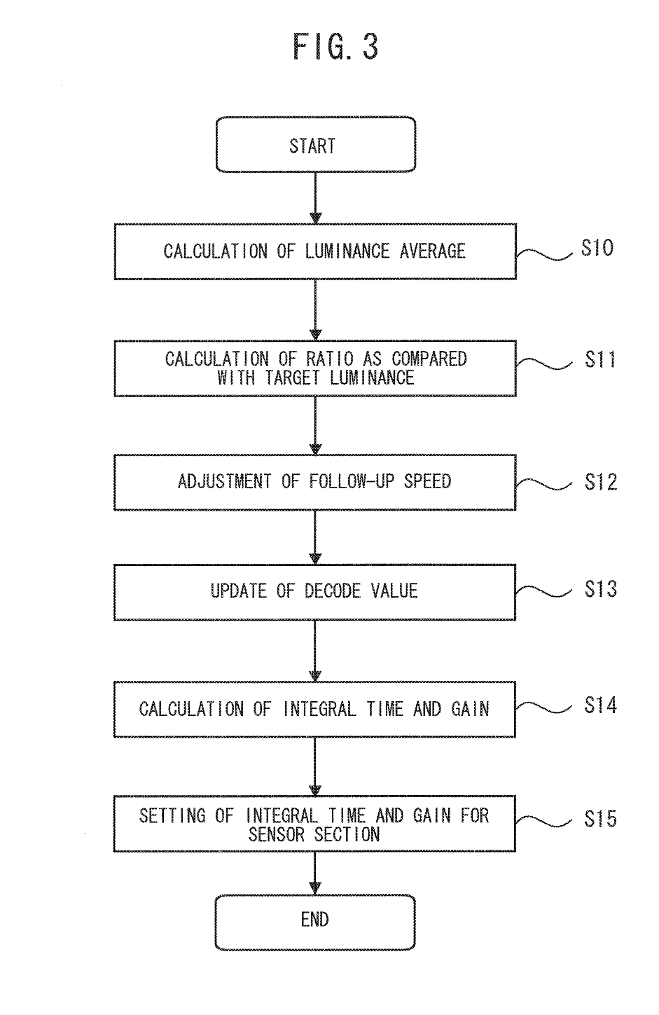

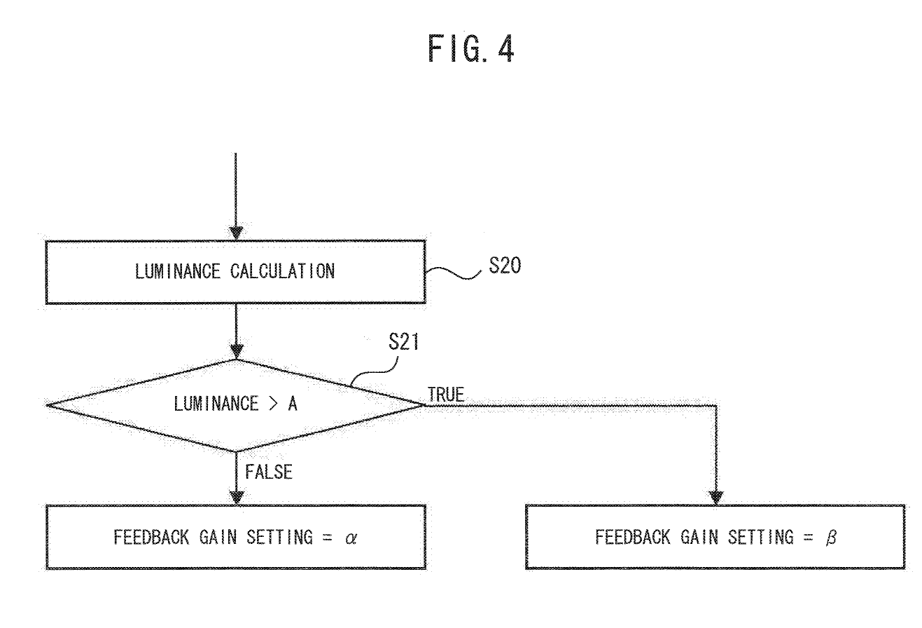

FIG. 3 and FIG. 4 are flowcharts for the process which allows the control cycle to be faster or slower in accordance with aspects of an embodiment.

FIG. 3 illustrates a control flow of AGC. In step S10, a luminance average is calculated, and in step S11, a ratio of the luminance average to the target luminance is calculated. In step S12, the follow-up speed is adjusted based on the luminance calculation. In step S13, the decode value of the luminance signal is updated so that the updated decode value exists between the current luminance and the target luminance. In step S14, an integral time (exposure time) and the gain are designated based on a table (not shown) which shows the relation among the decode value, the integral time and the gain. In step S15, the integral time and the gain are set in the image sensor, and processing is finished.

FIG. 4 illustrates a control flow for changing the follow-up speed (feedback gain) based on the luminance calculation result. Specifically, FIG. 4 illustrates a detailed process flow of step S12. In step S20, a luminance calculation is performed and a determination is made in step S21 whether the luminance is larger than a specified value (A). If the luminance is not larger than A, the value of the feedback gain is set as α (a first specified value). Since α is for the case of the luminance being small, it is set at a small value. If the luminance is larger than A, the setting value of the feedback gain is set as β (a second specified value). Since β is for the case of the luminance being large, β is set at a larger value than α in order to make the follow-up speed faster. In this way, the gain value may be specified in advance by comparing the luminance value with the specified value so that the gain value is specified for the case of the luminance value being larger or smaller. The integral time (exposure time) may also be determined in advance according to the luminance value similar to the way the gain value is determined. In order to change the follow-up speed, the speed of the control cycle for feeding back the gain value and the integral time may be varied. That is, when moving from a dark environment to a bright environment, the control may be performed so that the control cycle may be made fast. The speed of the control cycle may be determined in advance according to the luminance value, and then the speed of the control cycle may be set according to the calculated value of the luminance.

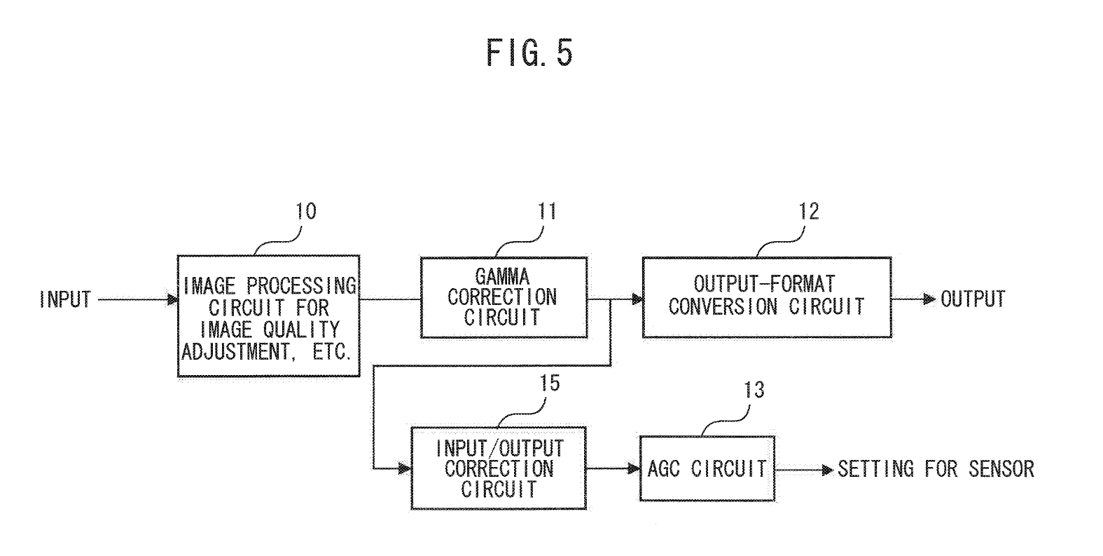

FIG. 5 is a block diagram of an image signal processing circuit according to a second embodiment.

In FIG. 5, like reference numerals are given to like elements as illustrated in FIG. 2, and the detailed description of such elements is omitted. In FIG. 5, an input/output correction circuit 15 having specified characteristics in reverse relation to the gamma correction circuit 11 is provided between the output of the gamma correction circuit 11 and the AGC circuit 13.

Thus, a control system for the AGC circuit is different from the display system, and there is provided a specialized circuit (the input/output correction circuit 15) which has characteristics in reverse relation to a correction curve such as gamma correction. The input/output correction circuit 15 converts the value received from the gamma correction circuit 11 to a value that is input to the AGC circuit 13. In other words, the input/output correction circuit reverse the correction made to the signal by the gamma correction circuit. This makes it possible to achieve the same effect as the first embodiment, where the AGC circuit received an input signal prior to gamma correction, even when a signal corrected with gamma correction is provided, by creating a uncorrected signal in a pseudo way.

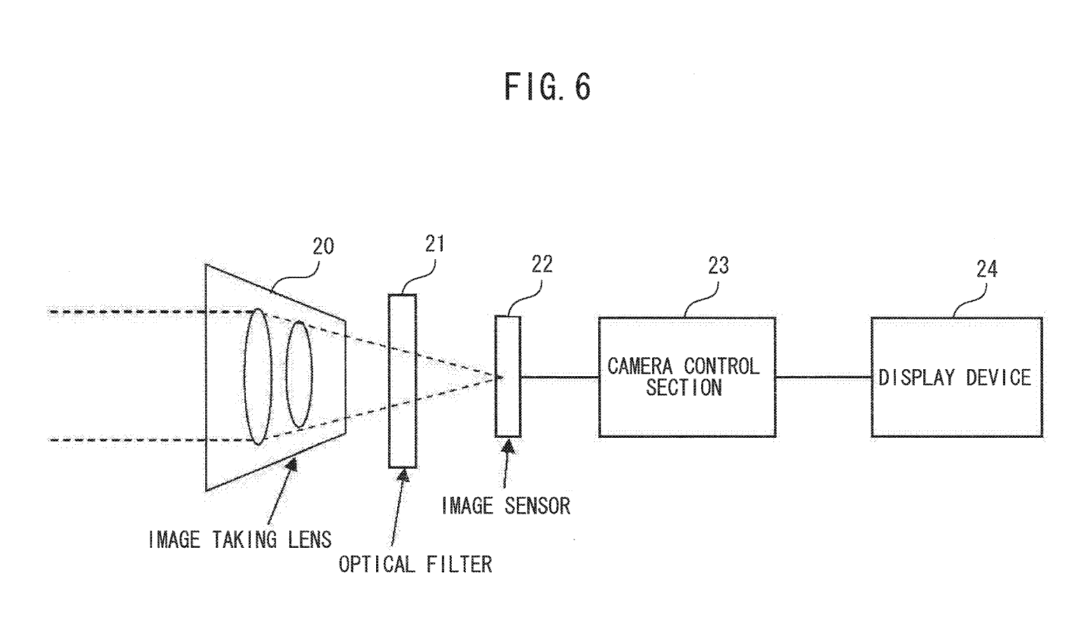

FIG. 6 is a block diagram of a typical digital camera.

The light focused by an image taking lens 20 passes through an optical filter 21, and is converted into an electrical signal by an image sensor 22. The signal acquired by the image sensor 22 is controlled by a camera control section 23 to be made into image data which is displayed by a display device 24.

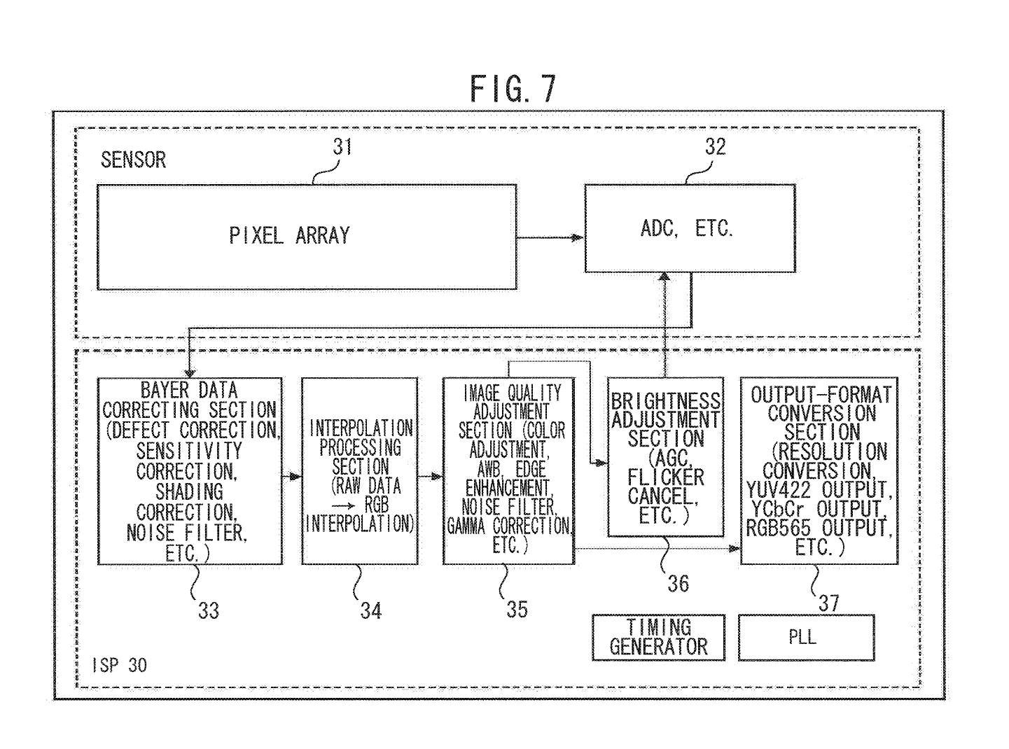

FIG. 7 is a block diagram of the image sensor of FIG. 6.

The image sensor includes an ISP (Image Signal Processor) 30. A pixel array 31 of the sensor converts the light into an electrical signal, which is then converted from an analog signal to a digital signal in an ADC, etc. 32. The converted, digital image signal is subject to defect correction, sensitivity correction, shading correction, noise filter correction, etc. in a Bayer data correcting section 33. Next, RGB interpolation of the raw data is performed in an interpolation processing section 34. Next, an image quality adjustment section 35 makes adjustments such as color adjustment, AWB (Auto White Balance) processing, edge enhancement processing, noise filter processing, gamma correcting, etc. are performed. In a brightness adjustment section 36, AGC processing, flicker cancellation processing, etc. are performed. The configuration including the AGC circuit of FIG. 2 corresponds to the portion related to the image quality adjustment section 35 and the brightness adjustment section 36. In an output-format conversion section 37, the conversion of the image output format in accordance with the format of resolution conversion, YUV422 output, YCbCr output, RGB565 output, etc. is performed. A PLL performs clock generation and a timing generator generates an operation timing of each section of ISP30.

Although the above embodiments are illustrated for the case where the gamma correction circuit is used as the correction circuit which performs the correction with characteristics in reverse relation to the luminance characteristics of the display device, aspects of the present invention is not limited to that case, and any means using the characteristics in reverse relation to the luminance characteristics of the display device can be applied to aspects of the present invention.

It should be noted that aspects of the embodiments cover, as applied to the luminance signal before correction in the correction circuit, can be applied not only to signals of the input side of the correction circuit, but also to signals of the output side of the correction circuit, which are further corrected in a reverse way relative to the correction of the correction circuit.

As described above, in accordance with aspects of the embodiments according to the present invention, the response speed of AE can be fast even for a large luminance variation. Therefore, this largely contributes to performance enhancement of the image sensor.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A signal processing circuit for processing a luminance signal from an image sensor for display on a display device, comprising:
a correction circuit for correcting characteristics of a luminance signal from the image sensor in reverse relation to luminance characteristics of the display device; and
a gain control section for performing gain control of the luminance signal from the image sensor based on the luminance signal from the image sensor, wherein the gain control signal receives an input signal corresponding to the luminance signal before correction of the luminance signal in the correction circuit.

2. The signal processing circuit according to claim 1, wherein the gain control section is configured to perform gain control by controlling an exposure time of the image sensor.

3. The signal processing circuit according to claim 1, wherein the gain control section is configured to perform gain control by controlling an amplification factor of the image signal.

4. The signal processing circuit according to claim 1,
further comprising a reverse correction circuit coupled between the correction circuit and the gain control circuit such that the reverse correction circuit receives the luminance signal after correction in the correction circuit and the luminance signal in reverse relation to the luminance characteristics of the correction circuit.

5. A signal processing circuit processing a luminance signal from an image sensor, comprising:
a level detecting section detecting a level of the luminance signal;
a gain control section controlling a gain of the luminance signal and having a control frequency; and
a frequency control section changing a control frequency of the gain control section in accordance with a variation of the level of the luminance signal detected by the level detecting section.

6. The signal processing circuit according to claim 5, wherein the control frequency is changed when the luminance signal level has risen.

7. The signal processing circuit according to claim 5, wherein a rate of changing the control frequency is changed depending on a rate of change of the luminance level.

8. A camera comprising:
an image sensor for outputting a luminance signal;
a display device
a correction circuit coupled to the image sensor for correcting characteristics of the luminance signal in reverse relation to luminance characteristics of the display device; and
a gain control section coupled to the image sensor for performing gain control of the luminance signal from the image sensor based on the luminance signal from the sensor, wherein the gain control section receives the luminance signal before correction of the luminance signal in the correction circuit.

9. An image sensing method for recording a luminance signal, comprising:
performing gain control of the luminance signal based on the luminance signal; and
applying to the luminance signal, a correction of characteristics in reverse relation to luminance characteristics of a display device.

10. An image taking method for recording a luminance signal from an image sensor, comprising:
detecting a level of the luminance signal;
controlling a gain of the luminance signal using a gain control section; and
changing a control frequency of the gain control section in accordance with a variation of the level of the luminance signal detected by the level detecting section.
